(19) United States
(12) Patent Application Publication
(10) Pub. No.: US 2022/0295474 A1
(43) Pub. Date: Sep. 15, 2022

(54) TERMINAL AND TRANSMISSION METHOD

(71) Applicant: Panasonic Intellectual Property Corporation of America, Torrance, CA (US)

(72) Inventors: Tomoya NUNOME, Ishikawa (JP); Hidetoshi SUZUKI, Kanagawa (JP); Takashi IWAI, Ishikawa (JP); Tetsuya YAMAMOTO, Kanagawa (JP)

(21) Appl. No.: 17/633,535

(22) PCT Filed: Jul. 28, 2020
(86) PCT No.: PCT/JP2020/028916

§ 371 Date: Feb. 7, 2022

(30) Foreign Application Priority Data
Aug. 15, 2019 (JP) 2019-149162

(51) Int. Cl. H04W 72/04; H04L 1/18

(52) U.S. Cl. CPC H04W 72/0413; H04W 72/0446; H04L 1/18

(57) ABSTRACT

The present invention contributes to the provision of a terminal and a transmission method which can improve the efficiency of the repetitive transmission of an uplink signal. The terminal is provided with: a transmission circuit which performs repetitive transmissions of an uplink signal in a plurality of time periods; and a control circuit which controls a time period in which a transmission opportunity of uplink control information is set among the plurality of time periods.

### TECHNICAL FIELD

The present disclosure relates to a terminal and a transmission method.

### BACKGROUND ART

In 3rd Generation Partnership Project (3GPP), the specification for Release 15 New Radio access technology (NR) has been completed for realization of 5th Generation mobile communication systems (5G) (see, for example, Non Patent Literatures (hereinafter referred to as NPLs) 1 to 4).

For example, transmission of uplink (UL) data from a terminal (or also referred to as User Equipment (UE)) based on a transmission occasion configured previously (e.g., transmission timing or radio resource) has been discussed in Release 15 NR.

### CITATION LIST

### Non Patent Literature

NPL 1

3GPP IS 38.211 V15.6.0, “NR; Physical channels and modulation (Release 15)”, June 2019.

NPL 2

3GPP TS 38.212 V15.6.0, “NR; Multiplexing and channel coding (Release 15)”, June 2019.

NPL 3

3GPP TS 38.213 V15.6.0, “NR; Physical layer procedure for control (Release 15)”, June 2019.

NPL 4

3GPP TS 38.214 V15.6.0, “NR; Physical layer procedures for data (Release 15)”, June 2019.

### SUMMARY OF INVENTION

There is scope for further study, however, on repetition uplink transmissions.

One non-limiting and exemplary embodiment facilitates providing a terminal and a transmission method each capable of improving efficiency of repetition transmission of an uplink signal.

A terminal according to an embodiment of the present disclosure includes: transmission circuitry, which, in operation, performs a repetition transmission of an uplink signal in a plurality of time periods; and control circuitry, which, in operation, controls at least one of the plurality of time periods in which a transmission occasion of uplink control information is configured.

A transmission method according to an embodiment of the present disclosure includes: controlling at least one of a plurality of time periods in which a transmission occasion of uplink control information is configured; and performing a repetition transmission of an uplink signal in the plurality of time periods.

It should be noted that general or specific embodiments may be implemented as a system, an apparatus, a method, an integrated circuit, a computer program, a storage medium, or any selective combination thereof.

According to an exemplary embodiment of the present disclosure, it is possible to improve efficiency of repetition transmission of an uplink signal.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates a configuration example of part of a base station according to an embodiment of the present disclosure;

FIG. 2 illustrates a configuration example of part of a terminal according to an embodiment of the present disclosure;

FIG. 3 is a block diagram illustrating a configuration example of a base station according to Embodiment 1;

FIG. 4 is a block diagram illustrating a configuration example of a terminal according to Embodiment 1;

FIG. 5 illustrates exemplary transmission-start candidate timings according to Embodiment 1;

FIG. 6 illustrates an example of determination method 1-1 according to Embodiment 1;

FIG. 7 illustrates an example of failure of the base station in detection of UL transmission by the terminal according to Embodiment 1;

FIG. 8 illustrates an example of determination method 1-2 according to Embodiment 1;

FIG. 9 illustrates the first example of determination method 2 according to Embodiment 1;

FIG. 10 illustrates the second example of determination method 2 according to Embodiment 1;

FIG. 11 illustrates the third example of determination method 2 according to Embodiment 1;

FIG. 12 illustrates an exemplary combination of the determination methods according to Embodiment 1;

FIG. 13 is a block diagram illustrating a configuration example of a terminal according to Embodiment 2;

FIG. 14 illustrates an example of transmission method 1 according to Embodiment 2;

FIG. 15 illustrates another example of transmission method 1 according to Embodiment 2; and

FIG. 16 illustrates an example of transmission method 2 according to Embodiment 2.

### DESCRIPTION OF EMBODIMENTS

Hereinafter, embodiments of the present disclosure will be described in detail with reference to the accompanying drawings.

### Embodiment 1

In 3rd Generation Partnership Project (3GPP), the specification for Release 15 New Radio access technology (NR) has been completed for realization of 5th Generation mobile communication systems (5G). NR supports functions for realizing Ultra Reliable and Low Latency Communication (URLLC) as well as high-speed and large capacity that are requirements for enhanced Mobile Broadband (eMBB) (see, for example, NPLs 1 to 4).

In Release 15 NR, Configured grant transmission (or referred to as Grant-free transmission) is supported for transmission of uplink data (e.g., Physical Uplink Shared Channel (PUSCH)). In the Configured grant transmission, a terminal semi-statically continues transmission based on a previously configured transmission occasion (e.g., transmission timing and a radio resource). In addition, in the Configured grant transmission, repetition transmission that repeatedly transmits the same data for a certain period of time is supported.

Further, in Release 16 NR, studies are carried out on NR-Unlicensed (NR-U) in which communication based on the radio access method in NR is performed in an unlicensed frequency band. The unlicensed frequency band is provided on condition that Listen Before Talk (LBT) is performed, which is to check, before transmission, whether a radio channel is in use by another system or terminal.

The LBT may be replaced with another function or method, for example, career sensing, which checks whether the radio channel is in use. The term “condition” may also be replaced with terms such as a “regulation” or a “constraint.”

In the Configured grant transmission in NR-U, enhancement in functionality from Release 15 NR is studied to meet the condition of the unlicensed frequency.

There is scope for further study on the repetition transmission in the Configured grant transmission in NR-U. For example, in the repetition transmission, transmission of control data has not been fully discussed.

A non-limiting embodiment of the present disclosure describes a transmission method of control information (e.g., UCI) in repetition transmission of a Configured grant.

### Configured Grant Transmission

A description will be given of Configured grant transmission supported by Release 15 NR. The Configured grant transmission for uplink data in Release 15 NR includes “Configured grant type 1 transmission” and “Configured grant type 2 transmission.”

In Configured grant type 1 transmission, information such as a Modulation and Coding Scheme (MCS), radio resource allocation information (e.g., allocation of time resource or frequency resource), the transmission timing, and the number of Hybrid Automatic Repeat request (HARQ) processes is configured by a terminal-specific higher layer signal (e.g., Radio Resource Control: RRC). When uplink data is generated, a terminal transmits the uplink data (e.g., PUSCH) by using information such as the MCS and the radio resource (e.g., Configured grant configuration information), which are configured previously, without an UL grant (scheduling information for dynamic uplink data) from base station (also referred to as gNB) by a downlink control channel (Physical Downlink Control Channel: PDCCH).

In Configured grant type 2 transmission, the Configured grant transmission is Activated or Released by PDCCH from a base station. In the Configured grant type 2 transmission, information such as the transmission timing and the number of HARQ processes is configured by the terminal-specific higher layer signal as well as the Configure grant type 1 transmission. On the other hand, in the Configured grant type 2 transmission, information such as the MCS and the radio resource allocation information is configured by Downlink Control Information (DCI) for Activation. When uplink data is generated, the terminal transmits the uplink data (e.g., PUSCH) by using, in a semi-permanent (or static or semi-static) manner (in other words, without the UL grant), Configured grant configuration information such as the MCS and the radio resources which are configured by the higher layer signal and the DCI for Activation.

Note that, in the following, transmitting uplink data and/or the like by using PUSCH may be described as “transmit PUSCH” or “PUSCH transmission.”

In Release 15 NR, the UL grant is used for retransmission control of the Configured grant transmission. The UL grant controls the MCS and the radio resource allocation information of uplink data for retransmission.

HARQ process ID used in the Configured grant transmission is uniquely determined by the slot number in which PUSCH is transmitted, as a non-limiting example. PUSCH transmitted in the Configured grant Transmission is considered as initial transmission, and the Redundancy Version (RV) thereof is zero.

In the repetition transmission, the same Transport Block (TB) is transmitted consecutively in different slots. A candidate for the number of repetitions is, for example, either 2, 4, or 8. The candidate for the number of repetitions is configured semi-statically, for example. In the RV, a pattern to be applied is configured semi-statically, for example. A pattern of the RV to be configured may be referred to as a RV sequence.

In Release 15, the RV sequence can be configured with the following three patterns: {0,2,3,1}, {0,3,0,3}, and {0,0,0,0}. Among K repetition transmissions (repetition transmission in K slots), the (mod (n-1, 4)+1)-th RV in the RV sequence is applied for an n-th transmission timing (n-th slot). Incidentally, a terminal may start transmission from the middle of the K repetitions (K slots). In this case, RV may be applied from an RV in the middle instead of the first RV in the RV sequence.

### Configured Grant Transmission in NR-U

In the Configured grant transmission in NR-U, some of the parameters used for decoding PUSCH such as the HARQ process ID and the RV are indicated from the terminal to the base station by Configured grant Uplink Control Information (CG-UCI).

The CG-UCI is transmitted, using a portion of the radio resource allocated to PUSCH, in the same transmission timing (e.g., the same slot) as PUSCH, for example. In NR-U, the reason for explicitly indicating the HARQ process ID by using the CG-UCI is as follows: in NR-U, PUSCH is not always transmitted depending on a result of Listen Before Talk (LBT), and thus, there is a possibility that the HARQ process may not be used flexibly in a method for determining the HARQ process ID in association with the transmission timing. In addition, NR-U supports an operation of retransmission to be performed by the terminal upon reception of a Negative ACKnowledgement (NACK) or by time expiration, without the UL grant indication, by using the radio resource configured for the Configured grant. The CG-UCI transmits the RV in order to match the recognition of a value of the RV (hereinafter referred to as an RV value) used for the retransmission between the base station and the terminal.

The present disclosure describes, as an example, transmission of the control information (e.g., UCI) in the repetition transmission of the Configured grant.

### CG-UCI Transmission in Repetition Transmission

As discussed above, in the Configured grant transmission, the CG-UCI is transmitted while being superimposed on PUSCH. On the other hand, in the repetition transmission, when the RV value of each transmission timing (for example, each slot) is set semi-statically by the RV sequence, the indication of the RV by the CG-UCI need not be required. In addition, the HARQ process ID and new data indicator (NDI) may be changed dynamically, and thus, it is desirable to perform indication by the CG-UCI, but the same configured value may be used during a repetition transmission period.

Thus, in a case where a setting value of the CG-UCI need not be changed during the repetition transmission period or in a case where, such as RV, the setting value is known even when it is changed and need not be indicated, it is assumed that the CG-UCI need not be transmitted for each transmission timing.

Hence, in Embodiment 1, a description will be given of a method for reducing overhead of signaling by reducing the number of CG-UCI transmissions in the repetition transmission of the Configured grant.

### Configuration of Radio Communication System

A radio communication system according to Embodiment 1 of the present disclosure includes at least one base station and at least one terminal.

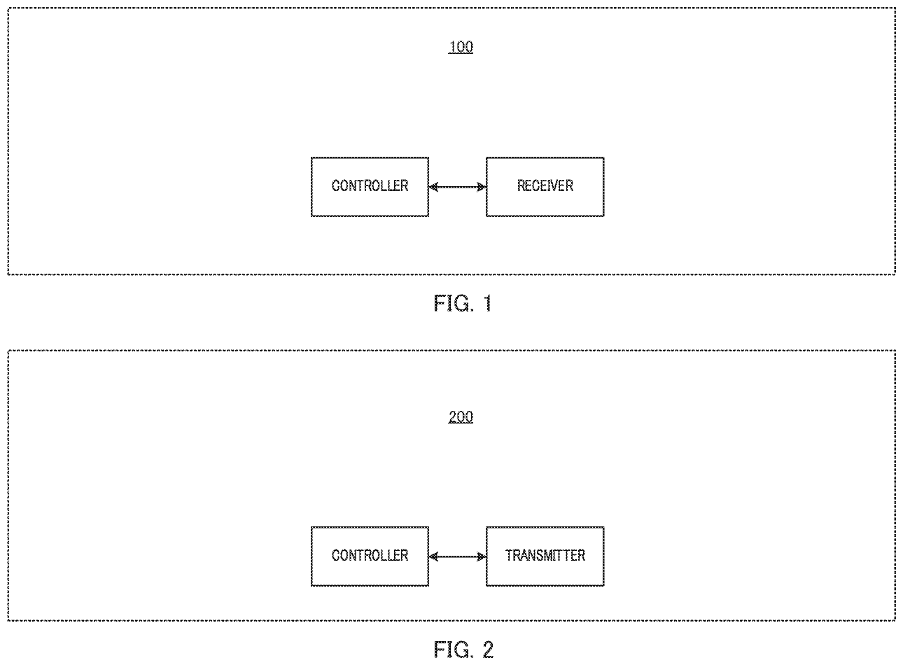

FIG. 1 illustrates a configuration example of part of base station 100 according to an embodiment of the present disclosure. In base station 100 illustrated in FIG. 1, a receiver performs repetition reception of an uplink signal (e.g., PUSCH) in a plurality of time periods (e.g., slot). A controller separates uplink control information (e.g., CG-UCI) from the uplink signal received in the plurality of time periods.

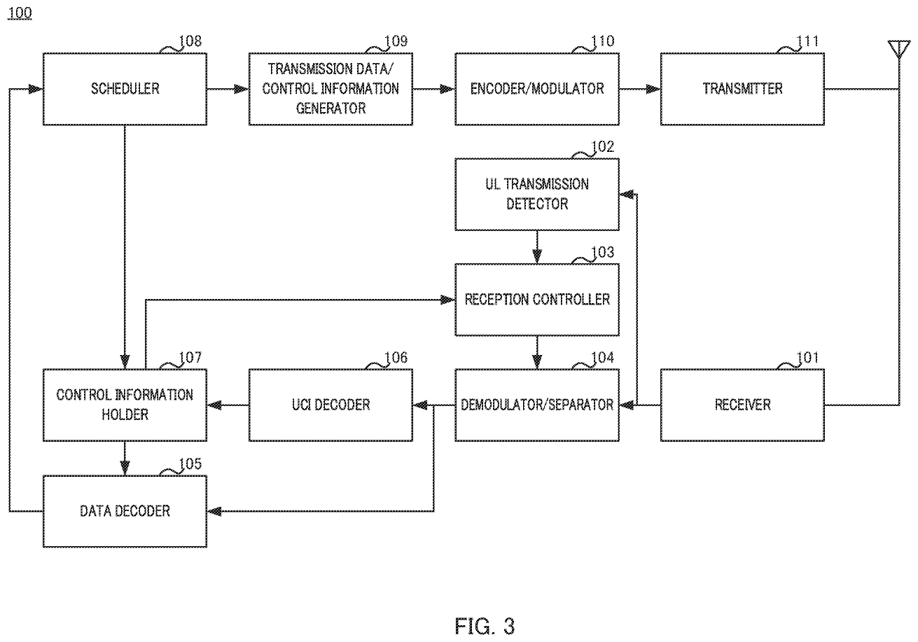

FIG. 2 illustrates a configuration example of part of terminal 200 according to an embodiment of the present disclosure. In terminal 200 illustrated in FIG. 2, a transmitter performs repetition transmission of an uplink signal (e.g., PUSCH) in a plurality of time periods (e.g., slot). A controller controls a time period in which a transmission occasion of the uplink control information e.g., CG-UCI) is configured in the plurality of time periods.

### Configuration of Base Station

FIG. 3 is a block diagram illustrating a configuration example of base station 100 according to the present embodiment. Base station 100 illustrated in FIG. 3 includes, for example, receiver 101, UL transmission detector 102, reception controller 103, demodulator/separator 104, data decoder 105, UCI decoder 106, control information holder 107, scheduler 108, transmission data/control information generator 109, encoder/modulator 110, and transmitter 111.

For example, the receiver illustrated in FIG. 1 may correspond to receiver 101 illustrated in FIG. 3. Further, the controller illustrated in FIG. 1 may correspond to processors (e.g., UL transmission detector 102, reception controller 103, demodulator/separator 104, and UCI decoder 106) related to reception processing of the uplink control information in FIG. 3 (e.g., CG-UCI).

Receiver 101 performs reception processing such as a down-conversion and/or A/D conversion for a received signal received via the antenna and outputs the received signal to UL transmission detector 102 and demodulator/separator 104.

UL transmission detector 102 uses the received signal input from receiver 101 (e.g., a reference signal included in the received signal (e.g., Demodulation Reference Signal (DMRS)) to detect the signal transmitted by terminal 200 (UL transmission), and outputs UL transmission detection indication to reception controller 103.

Reception controller 103 performs reception control based on, for example, the UL-transmission detection indication from UL transmission detector 102 and the Configured grant configuration from control information holder 107. In one example, when detecting the UL transmission (when acquiring the UL transmission detection indication), reception controller 103 performs control on demodulator/separator 104. Moreover, reception controller 103 determines the transmission timing (reception timing in base station 100) of the CG-UCI based on the Configured grant configuration information. Reception controller 103 indicates, to demodulator/separator 104, CG-UCI-presence/absence information indicating a determination result.

Demodulator/separator 104 performs demodulation and separation processes for the UL transmission under the control of reception controller 103. Demodulator/separator 104 performs demodulation of the received signal input from receiver 101. Demodulator/separator 104 separates a data signal and the CG-UCI from a demodulated received signal when the CG-UCI is included in the received signal (i.e., the CG-UCI-presence/absence information indicates that the CG-UCI is present). Demodulator/separator 104 outputs a demodulated data signal to data decoder 105. Meanwhile, demodulator/separator 104 outputs demodulated CG-UCI to UCI decoder 106 when the CG-UCI is included in the received signal.

Data decoder 105 decodes the demodulated data signal input from demodulator/separator 104 and outputs a decoding result to scheduler 108.

UCI decoder 106 decodes the demodulated UCI input from demodulator/separator 104 and outputs UCI information to control information holder 107.

Control information holder 107 holds the Configured grant configuration information for each terminal 200 (e.g., MCS, radio resource allocation information, the number of repetitions, RV-sequence, and the like) and outputs the Configured grant configuration information to each section. Control information holder 107 holds the control information from terminal 200 included in the UCI information and outputs the control information to data decoder 105.

Scheduler 108 determines and outputs the Configured grant configuration information for terminal 200 to control information holder 107. Scheduler 108 also outputs signaling information including the Configured grant configuration information to transmission data/control information generator 109. In addition, scheduler 108 indicates, to transmission data/control information generator 109, generation of HARQ-ACK feedback or generation of UL grant, based on a decoding result input from data decoder 105.

Transmission data/control information generator 109 generates transmission data based on the signaling information input from scheduler 108. Transmission data/control information generator 109 then outputs the generated transmission data to encoder/modulator 110. Transmission data/control information generator 109 also generates information for retransmission control (hereinafter may be also referred to as “retransmission control information”) (e.g., HARQ-ACK feedback information and UL grant information) based on the indication of scheduler 108. Transmission data/control information generator 109 outputs the generated retransmission control information to encoder/modulator 110.

Encoder/modulator 110 encodes and modulates the transmission data and/or the control information (e.g., retransmission control information) input from transmission data/control information generator 109 and generates a transmission signal. Encoder/modulator 110 outputs the transmission signal to transmitter 111.

Transmitter 111 performs transmission processing such as a D/A conversion, an up-conversion, and amplification for the transmission signal input from encoder/modulator 110 and transmits, from the antenna to terminal 200, a radio signal obtained by the transmission processing.

### Configuration of Terminal

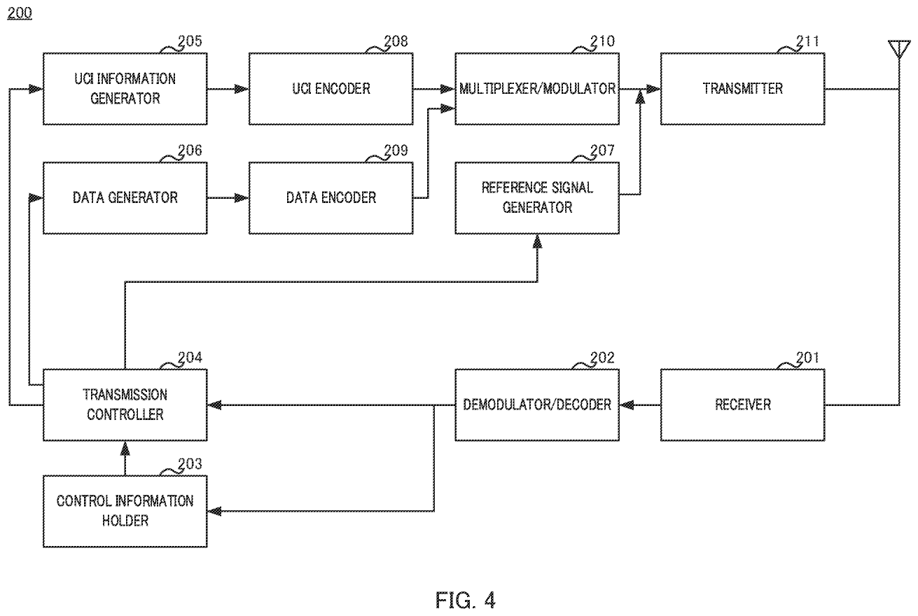

FIG. 4 is a block diagram illustrating a configuration example of terminal 200 according to the present embodiment. Terminal 200 illustrated in FIG. 4 includes receiver 201, demodulator/decoder 202, control information holder 203, transmission controller 204, UCI information generator 205, data generator 206, reference signal generator 207, UCI encoder 208, data encoder 209, multiplexer/modulator 210, and transmitter 211.

For example, the transmitter illustrated in FIG. 2 may correspond to transmitter 211 illustrated in FIG. 4. Moreover, the controller illustrated in FIG. 2 may correspond to processors (e.g., transmission controller 204 and UCI information generator 205) related to control on the configuration of the transmission occasion of uplink control information (e.g., CG-UCI) in FIG. 4.

Receiver 201 performs reception processing such as a down-conversion and/or A/D conversion for a received signal received via the antenna and outputs the received signal to demodulator/decoder 202.

Demodulator/decoder 202 performs demodulation and decoding for the received signal input from receiver 201. When a decoded signal includes the retransmission control information, demodulator/decoder 202 outputs the retransmission control information to transmission controller 204. When the decoded signal includes the signaling information from base station 100, demodulator/decoder 202 outputs the signaling information to control information holder 203.

Control information holder 203 inputs the signaling information from demodulator/decoder 202 and holds the control information such as the Configured grant configuration information. Control information holder 203 outputs the held control information to each of sections as needed.

Transmission controller 204 performs transmission control based on the Configured grant configuration information input from control information holder 203 and the retransmission control information input from demodulator/decoder 202. For example, transmission controller 204 determines whether it is the transmission timing of data and/or control information (transmission timing of the Configured grant and/or transmission timing of the CG-UCI). Transmission controller 204 gives indications to data generator 206, reference signal generator 207, and UCI information generator 205, according to a determination result. For example, in a case of determining as the transmission timing of data, transmission controller 204 indicates, to data generator 206, generation of data and indicates, to reference signal generator 207, generation of a reference signal. On the other hand, in a case of determining as the transmission timing of CG-UCI, transmission controller 204 indicates, to generator 205, generation of CG-UCI.

UCI information generator 205 generates CG-UCI information based on the CG-UCI generation indication input from transmission controller 204. UCI information generator 205 outputs UCI information to UCI encoder 208.

Data generator 206 generates transmission data based on the data generation indication input from transmission controller 204. Data generator 206 outputs the generated data to data encoder 209.

Reference signal generator 207 generates a reference signal based on the reference signal generation indication input from transmission controller 204. Reference signal generator 207 outputs the generated reference signal to transmitter 211.

UCI encoder 208 encodes the CG-UCI information input from UCI information generator 205 and outputs encoded UCI information to multiplexer/modulator 210.

Data encoder 209 encodes the transmission data input from data generator 206 and outputs the encoded transmission data to multiplexer/modulator 210.

Multiplexer/modulator 210 performs multiplexing and modulation for the encoded UCI information input from UCI encoder 208 and the encoded transmission data input from data encoder 209 and thereby generates a transmission signal. Multiplexer/modulator 210 outputs the transmission signal to transmitter 211.

Transmitter 211 performs transmission processing such as a D/A conversion, up-conversion, and/or amplification, for the signal input from multiplexer/modulator 210 and transmits, from the antenna to base station 100, a radio signal obtained by the transmission processing.

Operations in base station 100 and terminal 200 having the above configurations will be described in detail.

### Determination Method for CG-UCI Transmission Timing

A description will be given of a determination method for transmission occasion (e.g., transmission timing) of the CG-UCI in terminal 200 (e.g., transmission controller 204). Note that, the transmission timing of the CG-UCI in terminal 200 may correspond to a reception timing of the CG-UCI in base station 100 that receives the CG-UCI. Reception controller 103 of base station 100 may determine the reception timing of the CG-UCI with a method similar to the below-described method for determining the transmission timing of the CG-UCI.

The transmission occasion of the CG-UCI may be determined, for example, for a time period (e.g., slot). Alternatively, the transmission occasion of the CG-UCI may be determined for a radio resource (e.g., PUSCH).

### Determination Method 1

In determination method 1, the CG-UCI is transmitted while being superimposed on any of PUSCH of transmission-start candidate timings, The transmission-start candidate timing refers to a transmission timing serving as a candidate for the timing to start the repetition transmission. In one example, the transmission-start candidate timing in Rel.15 NR is defined by the number of repetitions and the RV sequence.

For example, Rel. 15 NR defines three RV sequences: {0,2,3,1}; {0,3,0,3}; and {0,0,0,0}. The following transmission-start candidate timings are defined for these three RV sequences: {0,2,3,1}: the first transmission timing in the repetition transmission; {0,3,0,3}: transmission timing when RV=0; and {0,0,0,0}: transmission is possible from any transmission timing. However, in a case where the number of repetitions is eight, the transmission is not started in the eighth transmission timing.

Note that, the reason the transmission is not started in the eighth transmission timing when the number of repetitions is eight (for example, when communication quality is low) is because the number of repetitions is small and the reception is unlikely to be successful in the base station even when the transmission is started from the eighth transmission timing.

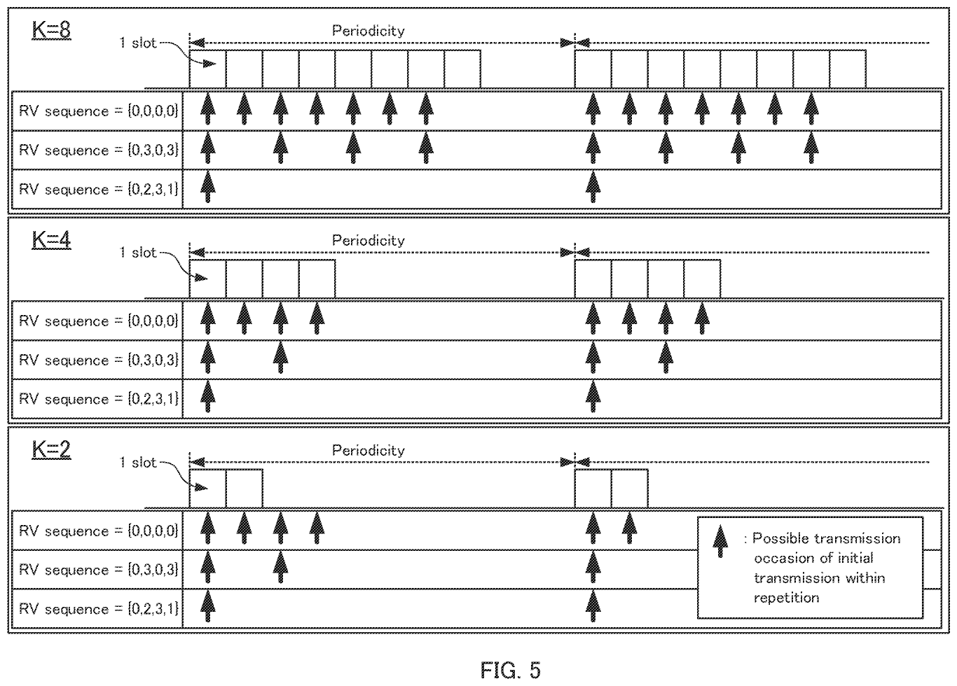

FIG. 5 illustrates exemplary transmission-start candidate timings according to Embodiment 1. FIG. 5 illustrates examples of transmission-start candidate timings defined by each of the number of repetitions K=8, 4, and 2 and each of the above-described three RV sequences.

For example, as illustrated in FIG. 5, transmitting the CG-UCI in at least one of the transmission-start candidate timings restricts the number of CG-UCI transmissions, so that the CG-UCI transmission can be reduced, and resources can be efficiently used.

In the example illustrated in FIG. 5, a plurality of transmission-start candidate timings is defined by the number of repetitions and the RV sequences. Next, a description will be given of a method for determining which transmission-start candidate timing to transmit the CG-UCI when a plurality of transmission-start candidate timings is present.

### Determination Method 1-1

In determination method 1-1, CG-UCI is transmitted while being superimposed on the first PUSCH transmission in the repetition transmission at a transmission-start candidate timing illustrated in FIG. 5. In other words, in determination method 1-1, terminal 200 determines, as the transmission timing to transmit the CG-UCI, the transmission timing (e.g., slot) in which the first PUSCH transmission in the repetition transmission is performed from among the transmission-start candidate timings illustrated in FIG. 5.

Terminal 200 may start the PUSCH transmission from any transmission-start candidate timing. In determination method 1-1, terminal 200 superimposes the CG-UCI on the first PUSCH. Base station 100 decodes the CG-UCI superimposed on the first PUSCH, which allows PUSCH to be decoded including the PUSCH on which the CG-UCI is superimposed.

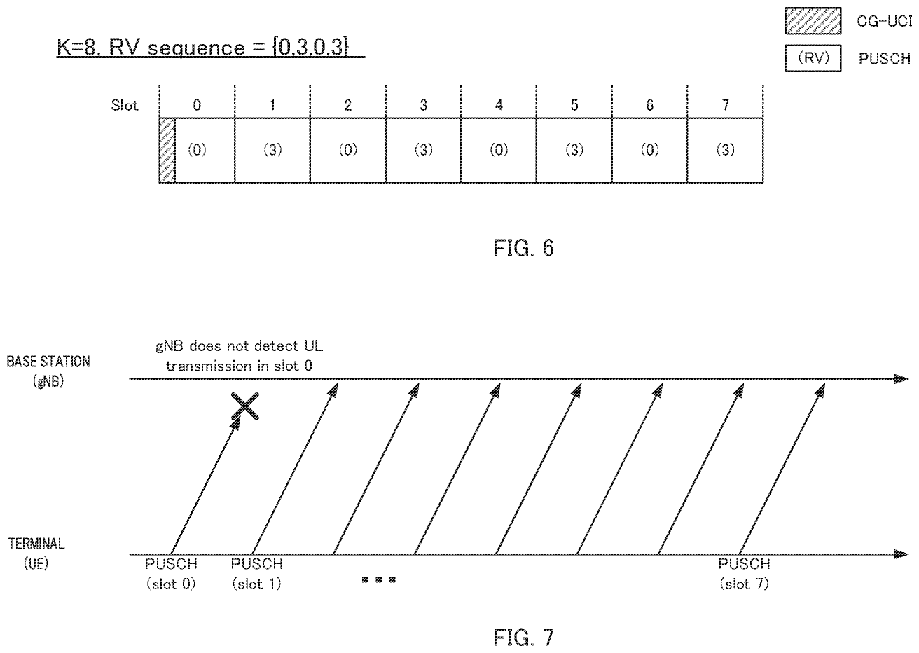

FIG. 6 illustrates an example of determination method 1-1 according to Embodiment 1. As an example, FIG. 6 illustrates the transmission timing of CG-UCI determined when the number of repetitions K=8 and the RV-sequence is {0, 3, 0, 3}.

In FIG. 6, the CG-UCI is superimposed on PUSCH transmission in slot 0 corresponding to the first PUSCH transmission among the transmission-start candidate timings when the number of repetitions K=8 and the RV-sequence is {0, 3, 0, 3}.

In determination method 1-1, as illustrated in FIG. 6, since the CG-UCI is transmitted in the first PUSCH transmission among the transmission-start candidate timings, the number of CG-UCI transmissions can be reduced, and resources can be efficiently used.

### Determination Method 1-2

In a radio environment where repetition transmission is applied (e.g., environment where radio communication quality is lower than expected quality), a base station may fail to detect UL transmission by a terminal.

FIG. 7 illustrates an example of failure of the base station in detection of UL transmission by the terminal. When the base station succeeds in detecting the UL transmission in the transmission-start candidate timing (e.g., slot 1 in FIG. 7) after the UL transmission which the base station has failed to detect (PUSCH of slot 0 in FIG. 7), the base station attempts to receive the CG-UCI, assuming that the timing of the successful detection is a transmission-start timing. However, when the CG-UCI is not included in the successfully detected UL transmission, the base station does not receive the CG-UCI and fails to decode PUSCH.

In order to avoid such a misrecognition between the terminal and the base station, in determination method 1-2, terminal 200 transmits the CG-UCI while superimposing the CG-UCI on a PUSCH, for example, in each of the transmission-start candidate timings among PUSCHs to be transmitted. In other words, in determination method 1-2, terminal 200 may determine each of the transmission-start candidate timings as the transmission timing of the CG-UCI.

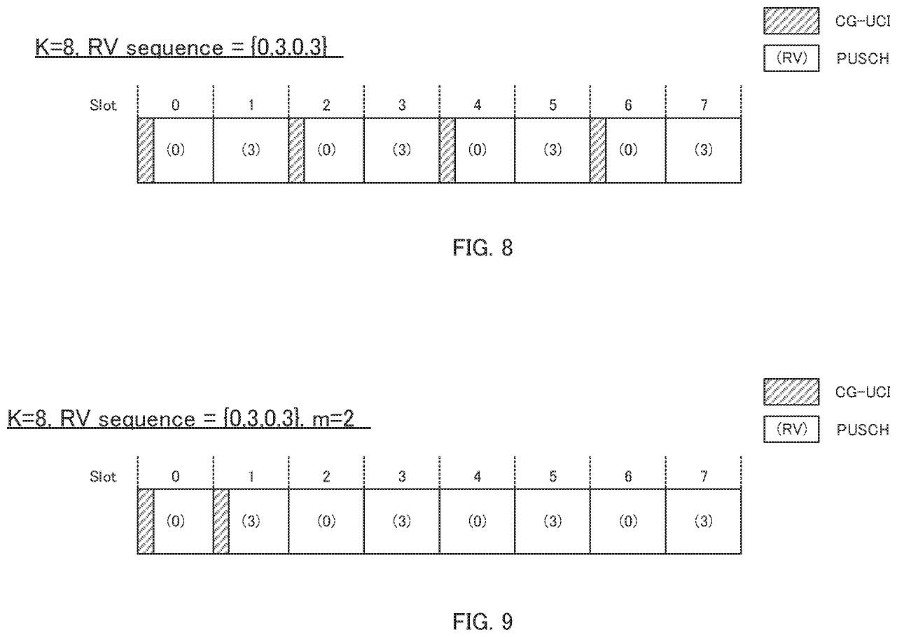

FIG. 8 illustrates an example of determination method 1-2 according to Embodiment 1. As an example, FIG. 8 illustrates the transmission timing of CG-UCI determined when the number of repetitions K=8 and the RV-sequence is {0, 3, 0, 3}.

In FIG. 8, the CG-UCI is superimposed on PUSCH transmission in slot 0, slot 2, slot 4, and slot 6, which is the transmission-start candidate timing when the number of repetitions K=8 and the RV-sequence is {0, 3, 0, 3}.

In determination method 1-2, as illustrated in FIG. 8, since the CG-UCI is transmitted in each of PUSCH transmission of the transmission-start candidate timings. Thus, even when base station 100 fails to detect the UL transmission, the reception of the CG-UCI is possible as long as base station 100 can detect UL transmission in at least one of the transmission-start candidate timings after the UL transmission that has not been successfully detected. Note that, this method is useful not only when the detection of UL transmission is failed, but also when the UL transmission is successfully detected but CG-UCI decoding is failed. For example, when the CG-UCI decoding is failed, PUSCH cannot be decoded during the repetition transmission period.

In the manner described above, in determination method 1-2, in addition to the reduction in the number of CG-UCI transmissions and the efficient use of resources, reception of the CG-UCI in the transmission timing after the reception failure is made possible even when the base station fails to detect the UL transmission or receive the CG-UCI; thus, more robust repetition transmission can be achieved.

### Determination Method 2

In determination method 1, the transmission timing of the CG-UCI is determined so that the CG-UCI is transmitted in any of the transmission-start candidate timings. In determination method 2, the CG-UCI is transmitted in the first m-th transmission timing in the repetition transmission.

FIG. 9 illustrates the first example of determination method 2 according to Embodiment 1. As an example, FIG. 9 illustrates the transmission timing of CG-UCI determined when the number of repetitions K=8, the RV-sequence is {0, 3, 0, 3}, and m=2.

In the example in FIG. 9, since m=2, the CG-UCI is transmitted in two-consecutive transmission timings from the timing when the transmission has been started. The timing in which the transmission can be started may or may not follow the timing of the transmission-start candidate timing as in determination method 1. In other words, terminal 200 may start the transmission from any transmission timing. For example, recognition of whether the timing in which the transmission can be started follows the transmission-start candidate timing is matched between base station 100 and terminal 200 in advance. For example, it may be defined by specification or may be configured using signaling between base station 100 and terminal 200.

Further, in a case where PUSCH is not transmitted consecutively, for example, when a slot for DL is present during the repetition period, the number of CG-UCIs may be counted as the number of actual transmissions, or may be counted in association with the transmission timing. For example, in the example in FIG. 9, when slot 1 is a DL slot, slot 1 may not be included in the count and may be counted twice by transmitting the CG-UCI in slot 2, or it may be counted twice including slot 1 although no transmission is actually made in slot 1.

When the reception processing of the base station is an operation which continues to detect the UL transmission in consecutive transmission timings, superimposing the CG-UCI on the consecutive transmission timings allows the CG-UCI to be received in a subsequent transmission timing even when UL transmission detection is failed and/or the CG-UCI receipt is failed. For example, in the case where the CG-UCI is transmitted to slot 0 and slot 1 as illustrated in FIG. 9, detecting the UL transmission in slot 1 allows the CG-UCI to be received in slot 1 PUSCH to be decoded even when the base station fails to detect of the UL transmission in slot 0.

Determination method 2 is a determination method based on the possibility that the UL transmission is not detected in a radio environment where the repetition is applicable. In determination method 2, in addition to the reduction in the number of CG-UCI transmissions and the efficient use of resources, more robust repetition transmission can be achieved even when the base station fails to detect the UL transmission or receive the CG-UCI, by allowing the CG-UCI to be received in the transmission timing after the reception failure.

Further, in determination method 2, the CG-UCI is transmitted continuously as long as the number of transmissions do not exceed the number of repetitions, without depending on the transmission-start candidate timing; thus, robust repetition transmission is achieved.

As mentioned above, in determination method 2, it is not required to follow the transmission-start candidate timing. In NR-U, transmission may not start from the beginning of the configured repetition period due to the effect of LBT. Thus, not following the transmission-start candidate timing provides an advantage of starting the transmission more flexibly and increasing the transmission occasion.

When not following the transmission-start candidate timing, the RV sequence may be applied from the transmission-start timing, or terminal 200 may indicate the determined RV value by the CG-UCI. When applying the RV sequence from the transmission-start timing, base station 100 can receive PUSCH with the intended RV sequence and does not have to indicate the RV by the CG-UCI, and thus, signaling can be reduced. When terminal 200 indicates the determined RV value by the CG-UCI, terminal 200 can more flexibly determine the RV value.

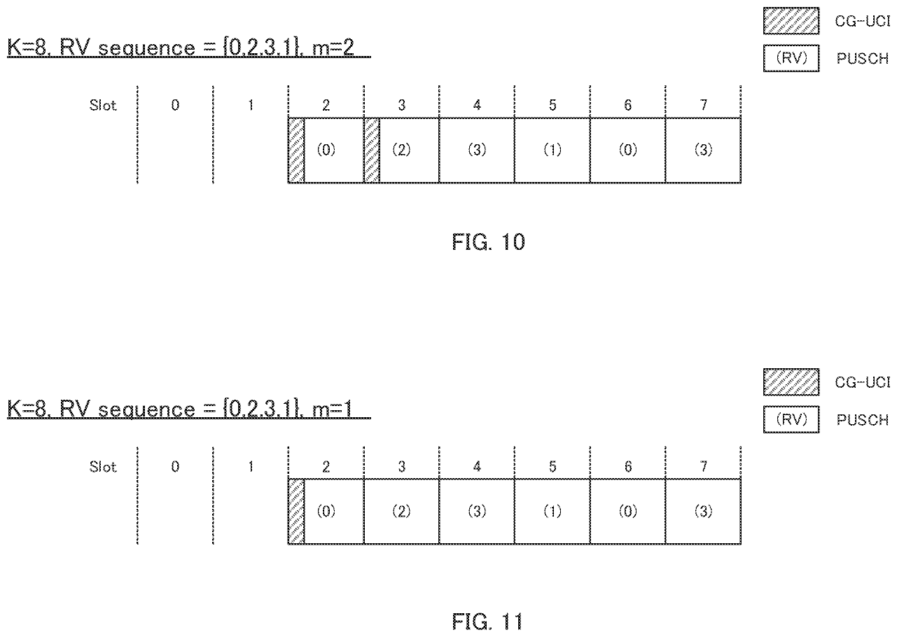

FIG. 10 illustrates the second example of determination method 2 according to Embodiment 1. As an example, FIG. 10 illustrates the transmission timing of CG-UCI determined when the number of repetitions K=8, the RV-sequence is {0, 2, 3, 1}, and m=2.

In the example in FIG. 10, the transmission is started from slot 2 that is in the middle of configured repetition transmission periods (slot 0 to slot 7) in a case of K=8. Then, the PUSCH transmission is performed based on RV sequence {0, 2, 3, 1} from slot 2 that is the transmission-start timing. In addition, the CG-UCI is transmitted in slot 2 and slot 3 which start the PUSCH transmission.

FIG. 11 illustrates the third example of determination method 2 according to Embodiment 1. As an example, FIG. 11 illustrates the transmission timing of the CG-UCI determined when the number of repetitions K=8, the RV-sequence is {0, 2, 3, 1}, and m=1.

In the example in FIG. 11, the PUSCH transmission is started from slot 2 that is in the middle of configured repetition transmission periods (slot 0 to slot 7) in a case of K=8. Then, the PUSCH transmission is performed based on RV sequence {0, 2, 3, 1} from slot 2 that is the transmission-start timing. In addition, the CG-UCI is transmitted in slot 2 which starts the transmission.

As illustrated in FIG. 10, when the CG-UCI is transmitted in a plurality of transmission timings (for example, when m is 2 or more), base station 100 may erroneously recognize the transmission-start timing, so that the CG-UCI may include a parameter by which the timing from which the transmission is started can be determined. The method for determining the transmission timing may be an index within the repetition period or an index value obtained by performing a modulo operation with a predetermined value. For example, a method may be applied in which an index value is obtained by performing the modulo operation with four so that the number of information bits to be notified falls within two bits. In addition, the method for determining the transmission timing may be an index of the RV sequence or a value of the RV.

On the other hand, as illustrated in FIG. 11, when the CG-UCI is transmitted in one transmission timing (for example, when m=1), base station 100 can determine that the timing in which the CG-UCI is received is the transmission-start timing, so that the CG-UCI need not to include the parameter by which the timing from which the transmission is started can be determined. For example, in the example in FIG. 11, when the base station can receive the CG-UCI in slot 2, base station 100 can recognize that the RV sequence is started from slot 2. Thus, it is unnecessary to explicitly indicate the transmission-start timing.

In determination method 2, in addition to the reduction in the number of CG-UCI transmissions and the efficient use of resources, more robust repetition transmission can be achieved even when the base station fails to detect the UL transmission or receive the CG-UCI, by allowing the CG-UCI to be received in the transmission timing after the reception failure. In addition, performing an operation not following the transmission-start candidate timing allows the transmission occasion to be increased even when the transmission is not performed from the beginning of the repetition transmission period due to LBT, for example.

As described above, in Embodiment 1, the resources can be effectively used by reducing the CG-UCI transmissions in the repetition transmission; as a result, it is possible to improve the efficiency of the repetition transmission when the terminal transmits the uplink data.

Note that, the determination methods described above may be combined with each other. For example, determination method 1 and determination method 2 may be combined in order to perform transmission in the first m-th timing among the transmission-start candidate timings.

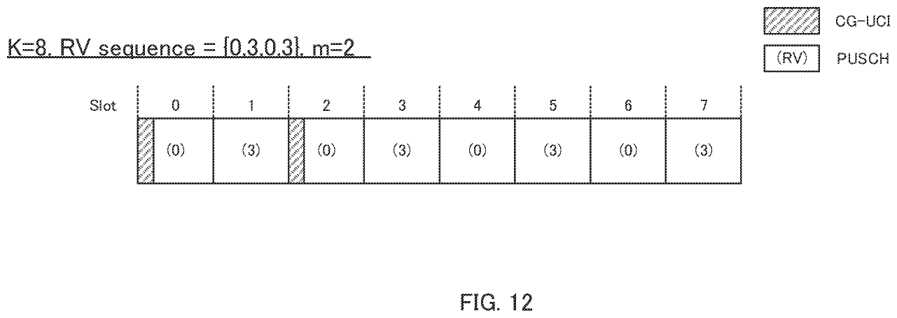

FIG. 12 illustrates an exemplary combination of the determination methods according to Embodiment 1. FIG. 12 illustrates the transmission timing of the CG-UCI determined when the number of repetitions K=8, the RV-sequence is {0, 3, 0, 3}, and m=2. This makes it possible to transmit the CG-UCI in the transmission-start candidate timing and to transmit the CG-UCI with the minimum number of transmissions, and thereby to efficiently use the resources. For example, the example illustrated in FIG. 12 is useful when base station 100 receives the UCI in the transmission-start candidate timing.

Note that, depending on the number of repetitions and the number of CG-UCIs, the amount of resources used in the CG-UCI may be varied. For example, when the number of CG-UCIs in repetition transmission periods is one, the amount of resources may be twice as large as that when the number of CG-UCIs is two. In addition, when the number of repetitions is eight, the amount of resources may be twice as large as that when the number of repetitions is four

In the manner described above, the CG-UCI is more likely to be received correctly even under the condition in which the number of CG-UCIs is low or communication quality is low (a case where a repetition is required to be performed many times due to low communication quality).

### Embodiment 2

In Embodiment 2, a description will be given of UCI for HARQ-ACKnowledgement (HARQ-ACK) and UCI for Channel State Information (CSI) feedback, in repetition transmission. The UCI for HARQ-ACK indicates, for example, the success or failure, determined by a terminal, in reception of a downlink signal, and the UCI for CSI feedback indicates a channel state estimated by the terminal, for example.

In PUSCH, not only CG-UCI but also the UCI for HARQ-ACK (hereinafter referred to as “ACK-UCI”) and/or the UCI for CSI feedback (hereinafter referred to as “CSI-UCI”) may be superimposed. The ACK-UCI and the CSI-UCI are transmitted in PUCCH, but are superimposed on PUSCH when, for example, transmission timings of the ACT-UCI and the CSI-UCI overlap the transmission timing of PUSCH.

Whether the terminal transmits the CSI-UCI and the transmission timing of the CSI-UCI when transmitting the CSI-UCI are configured semi-statically. Meanwhile, whether the terminal transmits the ACK-UCI and the transmission timing of the ACK-UCI when transmitting the ACK-UCI may be determined by PDCCH.

The repetition transmission is assumed to be configured when communication quality is low. Low communication quality may lead the terminal to fail to receive PDCCH. When failing to receive PDCCH, the terminal may not transmit the ACK-UCI. Meanwhile, a base station performs a reception operation assuming that the terminal transmits the ACK-UCI. Thus, regarding the presence/absence of transmission of the ACK-UCI, misrecognition occurs between the terminal and the base station, As a result, the base station cannot receive correctly HARQ-ACK included in the ACK-UCI.

In addition, in NR-U, the transmission timing of the CSI-UCI semi-statically configured and/or the transmission timing of the ACK-UCI configured by PDCCH may not be available due to the effect of LBT.

Hence, in Embodiment 2, a method will be described in which the transmission of the CSI-UCI and the ACK-UCI can be performed and the efficiency of repetition transmission can be thus improved even when PDCCH cannot be received and/or the configured transmission timings of the CSI-UCI and the ACK-UCI are not used due to the effect of LBT.

### Configuration of Base Station

A base station according to Embodiment 2 has a configuration similar to the configuration illustrated in FIG. 3 of Embodiment 1, but has some different functions. In the following, with reference to FIG. 3, a configuration example of the base station according to Embodiment 2 (hereinafter referred to as base station 300) will be described.

Reception controller 103 performs reception control based on the UL transmission detection indication input from UL transmission detector 102 and the configuration information input from control information holder 107. For example, when detecting the UL transmission (when acquiring UL transmission detection indication), reception controller 103 performs control on demodulator/separator 104.

Moreover, reception controller 103 determines the transmission timing of the CG-UCI based on the Configured grant configuration information. Reception controller 103 indicates CG-UCI-presence/absence information indicating a determination result to demodulator/separator 104.

Furthermore, reception controller 103 determines the transmission timing and a resource of the ACK-UCI based on the ACK-UCI configuration information input from control information holder 107. Reception controller 103 indicates ACK-UCI-presence/absence and resource information to demodulator/separator 104.

Further, reception controller 103 determines the transmission timing and a resource of the CSI-UCI based on the CSI-UCI configuration information input from control information holder 107. Reception controller 103 indicates CSI-UCI-presence/absence information and resource information to demodulator/separator 104.

Demodulator/separator 104 performs a demodulation process for the received signal and a separation process of data and each UCI from the received signal, based on the received signal input from receiver 101 and information from reception controller 103. For example, demodulator/separator 104 separates the CG-UCI from the received signal when the CG-UCI is received, based on the CG-UCI-presence/absence information. Moreover, demodulator/separator 104 separates the ACK-UCI from the received signal when the ACK-UCI is received, based on the ACK-UCI-presence/absence information and resource information. Furthermore, demodulator/separator 104 separates the CSI-UCI from the received signal when the ACK-UCI is received, based on the CSI-UCI-presence/absence information and resource information. Demodulator/separator 104 outputs demodulated data to data decoder 105 and outputs each demodulated UCI to UCI decoder 106.

UCI decoder 106 decodes each demodulated UCI input from demodulator/separator 104 and outputs information on each UCI to control information holder 107.

### Configuration of Terminal

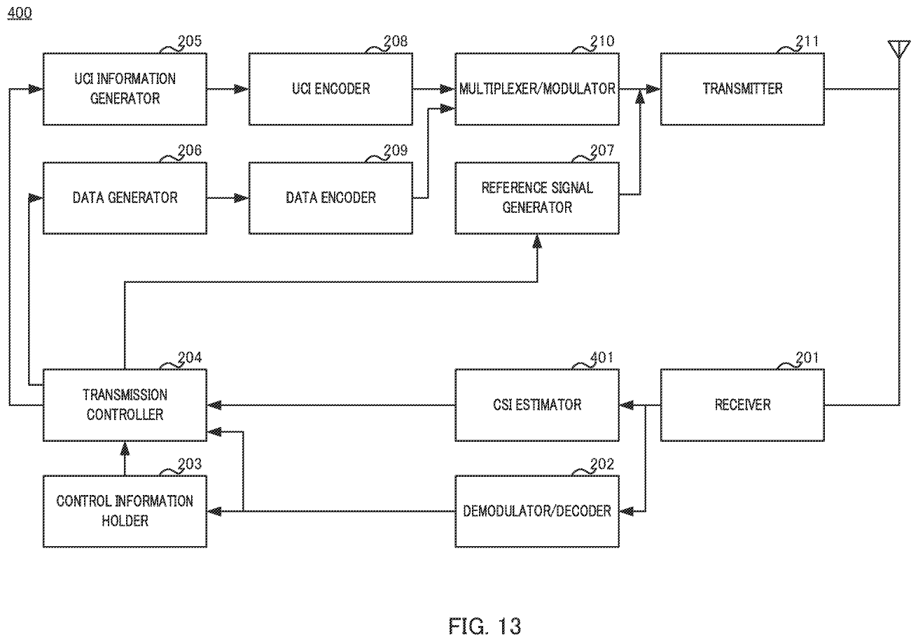

FIG. 13 is a block diagram illustrating a configuration example of terminal 400 according to Embodiment 2. With respect to the configuration in FIG. 4 described in Embodiment 1, CSI estimator 401 is added. Further, a description will be given below of a function in FIG. 13 that is different from the functions in FIG. 4 described in Embodiment 1.

Demodulator/decoder 202 performs demodulation and decoding for the received signal input from receiver 201. When a decoded signal includes the retransmission control information, demodulator/decoder 202 outputs the retransmission control information to transmission controller 204. Demodulator/decoder 202 also outputs a decoding result to transmission controller 204. When the decoded signal includes the signaling information from the base station, demodulator/decoder 202 outputs the signaling information to control information holder 203.

CSI estimator 401 performs CSI estimation based on the received signal input from receiver 201 and outputs a CSI estimation result to transmission controller 204.

Transmission controller 204 performs transmission control based on the Configured grant configuration information input from control information holder 203, the retransmission control information and the decoding result input from demodulator/decoder 202, and the CSI estimation result input from CSI estimator 401. For example, transmission controller 204 determines whether it is the transmission timing of data and/or control information (transmission timing of the Configured grant, transmission timing of the CG-UCI, transmission timing of the ACK-UCI, and/or transmission timing of the CSI-UCI). Transmission controller 204 gives indications to data generator 206, reference signal generator 207, and UCI information generator 205, according to a determination result

For example, in a case of determining as the transmission timing of data, transmission controller 204 indicates, to data generator 206, generation of data and indicates, to reference signal generator 207, generation of a reference signal. In a case of determining as the transmission timing of CG-UCI, transmission controller 204 indicates, to generator 205, generation of CG-UCI. In a case of determining as the transmission timing of ACK-UCI, transmission controller 204 indicates, to generator 205, generation of ACK-UCI. Note that, ACK-UCI generation indication includes ACK/NACK information determined based on a decoding result input from demodulator/decoder 202. Further, in a case of determining as the transmission timing of CSI-UCI, transmission controller 204 indicates, to generator 205, generation of CSI-UCI. Note that, CSI-UCI generation indication includes the CSI estimation result determined input from CSI estimator 401.

UCI information generator 205 generates CG-UCI information based on CG-UCI generation instruction input from transmission controller 204. UCI information generator 205 also generates HARQ-ACK information based on the ACK-UCI generation instruction input from transmission controller 204. Further, UCI information generator 205 generates the CSI information based on the CSI-UCI generation instruction input from transmission controller 204. UCI information generator 205 outputs the generated information to UCI encoder 208.

### Transmission Occasions of ACK-UCI and CSI-UCI

A description will be given of the transmission occasions of the ACK-UCI and the CSI-UCI (e.g. transmission timing or resource).

### Transmission Method 1

In transmission method 1, a transmission occasion of the ACK-UCI and a transmission occasion of the CSI-UCI are specified by the CG-UCI. In other words, terminal 400 configures the transmission occasion of the ACK-UCI and the transmission occasion of the CSI-UCI to any of repetition transmission periods and indicates information indicating configured transmission occasions by the CG-UCI. In this case, base station 300 receives the CG-UCI and, based on information included in the received CG-UCI, receives the ACK-UCI and the CSI-UCI.

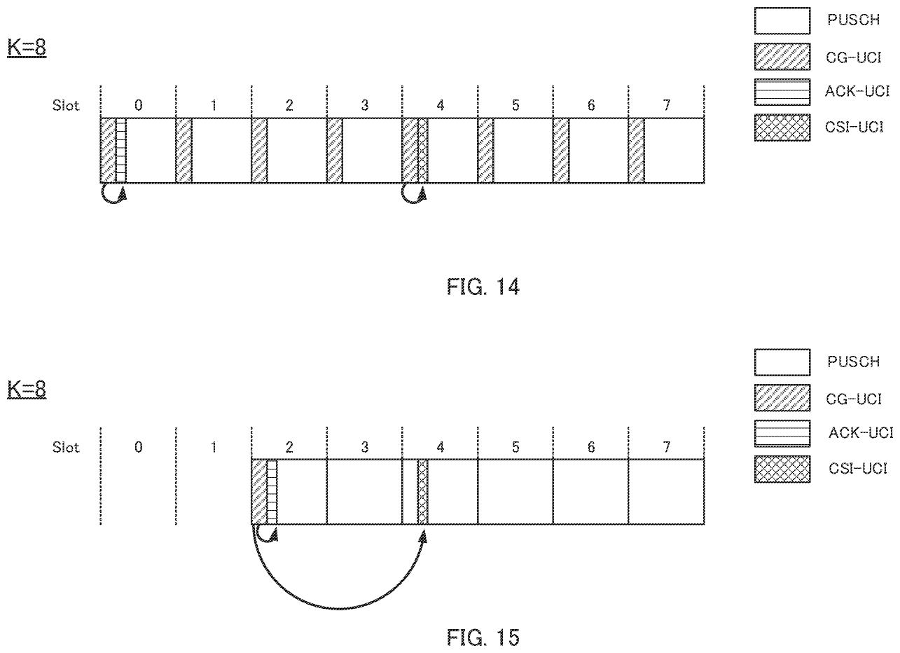

FIG. 14 illustrates exemplary transmission method 1 according to Embodiment 2. In FIG. 14, the CG-UCI is transmitted at each transmission timing (each slot). The CG-UCI then indicates the presence or absence of the UCI and, when the UCI is present, a resource of the UCI in the same transmission timing (same slot). For example, the CG-UCI transmitted in slot 0 in FIG. 14 includes information indicating a transmission timing and a resource of the ACK-UCI transmitted in slot 0. Further, the CG-UCI transmitted in slot 4 in FIG. 14 includes information indicating a transmission timing and a resource of the CSI-UCI transmitted in slot 4.

FIG. 15 illustrates another example of transmission method 1 according to Embodiment 2. FIG. 15 illustrates an example in which terminal 400 does not perform

PUSCH transmission in slot 0 and slot 1 due to the effect of LBT and starts the PUSCH transmission in slot 2. In this case, the CG-UCI is transmitted while being superimposed on the first PUSCH transmission (i.e., PUSCH transmission in slot 2).

For example, without above-described transmission method 1, even in a situation where the ACK-UCI is configured to be transmitted in slot 0, terminal 400 does not transmit the ACK-UCI when not performing the PUSCH transmission in slot 0 due to the effect of LBT. By contrast, in the example in FIG. 15 of transmission method 1 described above, even in a situation where the ACK-UCI is configured to be transmitted in slot 0 and terminal 400 does not perform the PUSCH transmission in slot 0 due to the effect of LBT, the ACK-UCI can be transmitted in slot 2 because the transmission occasion of the ACK-UCI (e.g., transmission timing or resource) is explicitly indicated by the CG-UCI. For example, since the CSI-UCI is transmitted in slot 4, the CG-UCI in slot 2 includes the transmission timing of the CSI-UCI.

Further, explicitly indicating, by the CG-UCI, the transmission occasion of the ACK-UCI (e.g. transmission timing or resource) allows terminal 400 to indicate the ACK-UCI to base station 300 regardless of whether terminal 400 succeeds or fails in receiving PDCCH, even under an environment with low communication quality where the repetition transmission is applied. Thus, the reliability of HARQ-ACK can be enhanced.

Further, for example, when terminal 400 cannot transmit the UCI in the originally configured transmission timing due to the effect of LBT, the UCI is transmitted at a transmission timing different from the configured transmission timing within the repetition transmission period. Such transmission method can increase a transmission occasion of feedback information. Thus, it is possible to reduce the retransmission and/or the feedback delay.

Thus, indicating, by the CG-UCI, the transmission timings or resources of the ACK-UCI and CSI-UCI makes it possible to enhance the reliability of HARQ-ACK even in an environment with low communication quality and to increase the transmission occasion of the feedback.

Note that, the resource need not be indicated. In addition, a plurality of pieces of feedback information in the repetition transmission period may be transmitted together.

### Transmission Method 2

In transmission method 2, the ACK-UCI is transmitted at a specific transmission occasion that is semi-statically configured (e.g. transmission timing or resource). In other words, terminal 400 transmits the ACK-UCI in the specific transmission occasion that is semi-statically configured. In this case, the specific transmission occasion that is semi-statically configured may be known between terminal 400 and base station 300. Base station 300 may receive the ACK-UCI in the specific transmission occasion that is semi-statically configured.

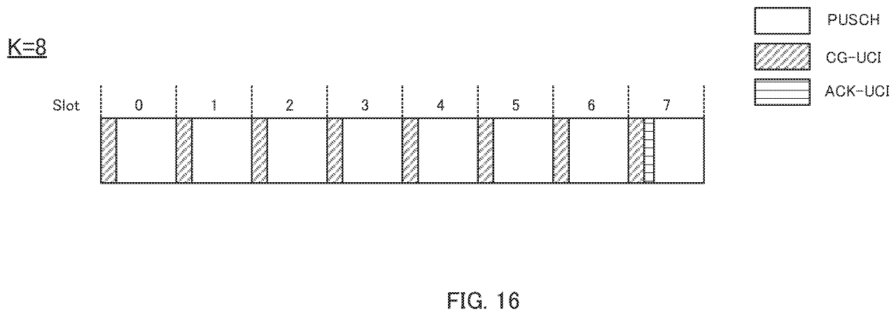

FIG. 16 illustrates exemplary transmission method 2 according to Embodiment 2. In FIG. 16, in each of slot 0 to slot 7, PUSCH transmission is performed on which the CG-UCI is superimposed. In addition, in FIG. 16, a transmission timing of the ACK-UCI is configured in slot 7.

Ensuring a specific transmission timing for transmission of the ACK-UCI makes it possible to prevent misrecognition between base station 300 and terminal 400 and to increase the reliability of HARQ-ACK feedback.

When transmitting HARQ-ACK within the repetition transmission period, terminal 400 uses the ensured transmission timing and resource. In a case where no HARQ-ACK is to be transmitted within the repetition transmission period, terminal 400 transmits the ACK-UCI indicating NACK. The case where no HARQ-ACK is to be transmitted within the repetition transmission period includes, for example, a case where not receiving PDCCH for determining whether to transmit the ACK-UCI and a transmission timing of the ACK-UCI when transmitting the ACK-UCI. Thus, even when terminal 400 fails to receive PDCCH, the ACK-UCI indicating NACK is indicated to base station 300, so that base station 300 can retransmit PDCCH transmission or the like.

Thus, semi-statically configuring the transmission timing and resource of the ACK-UCI makes it possible to enhance the reliability of HARQ-ACK feedback even in an environment with low communication quality.

As described above, in Embodiment 2, even when, in the repetition transmission, PDCCH cannot be received and/or the configured transmission timings of the CSI-UCI and the ACK-UCI are not used due to the effect of LBT, transmitting the CSI-UCI and the ACK-UCI is possible, and thus the efficiency of repetition transmission can be improved.

Note that, above-described Embodiments 1 and 2 may be combined with each other. For example, the ACK-UCI and/or CSI-UCI may be indicated by the CG-UCI to be transmitted in the transmission timing of the CG-UCI determined by any of the determination methods described in Embodiment 1.

Hereinabove, each embodiment of the present disclosure has been described.

### Other Embodiments

In each of the embodiments described above, a description has been given of the transmission of the control information (e.g., UCI) in the repetition transmission of the Configured grant. However, the present disclosure is not limited to this.

In addition, numerical values indicated in each of the embodiments above are merely examples, and the present disclosure is not limited to these. For example, the patterns of the number of repetition transmissions may include a number different from 2, 4, and 8, or any of 2, 4, and 8 may be excluded from the number. In addition, in each of the embodiments described above, the three patterns have been indicated as examples of the candidates of the RV sequence, but the candidate of the RV sequence may include a pattern different from the three patterns described above, or any of the three patterns described above may be excluded.

Further, the drawings described in each of the embodiments above have illustrated an example in which the CG-UCI is mapped to the beginning of the slot (front of PUSCH), the present disclosure is not limited to this. The CG-UCI may be mapped to a position different from the beginning of the slot (position different from the front of PUSCH).

An embodiment of the present disclosure may be applied to side link communication (i.e., direct communication between a plurality of terminals) as well as communication by an interface called a Uu interface (i.e., communication between base station and terminal, which may be referred to as communication of Uu link). For example, in the sidelink communication, an embodiment of the present disclosure may be applied when a terminal performs the Configured grant transmission for another terminal. In this case, for example, channel mapping in the Uu link (e.g., uplink and downlink) described in each of Embodiments above may be replaced with channel mapping in the sidelink. In one example, PUSCH may be replaced with a sidelink data channel (Physical Sidelink Shared Channel: PSSCH) and the UCI may be replaced with side link control information (Sidelink Control Information: SCI).

In the description described above, “ . . . er (or)” and “section” used for each component may be replaced with other terms such as “ . . . circuit (circuitry),” “ . . . device,” “ . . . unit,” and “ . . . module.”

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Interne of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A terminal according to an embodiment of the present disclosure includes: transmission circuitry, which, in operation, performs a repetition transmission of an uplink signal in a plurality of time periods; and control circuitry, which, in operation, controls at least one of the plurality of time periods in which a transmission occasion of uplink control information is configured.

In an embodiment of the present disclosure, the control circuitry configures the transmission occasion of the uplink control information in any of one or more candidate time periods in which transmission of the uplink signal is started among the plurality of time periods.

In an embodiment of the present disclosure, the control circuitry configures the transmission occasion of the uplink control information in a first time period among the plurality of time periods.

In an embodiment of the present disclosure, the control circuitry configures the transmission occasion of the uplink control information in each of the one or more candidate time periods in which the transmission of the uplink signal is started among the plurality of time periods.

In an embodiment of the present disclosure, the one or more candidate time periods in Which the transmission of the uplink signal is started are defined based on the number of the plurality of time periods and a parameter related to the repetition transmission.

In an embodiment of the present disclosure, the transmission circuitry starts transmission of the uplink signal from any of the plurality of time periods, and the control circuitry configures the transmission occasion of the uplink control information in m time period(s) (m is an integer of one or more) from the time period in which the transmission of the uplink signal is started.

In an embodiment of the present disclosure, the uplink control information indicates a transmission resource of information indicating success or failure in reception of a downlink signal and/or of information indicating a channel state.

In an embodiment of the present disclosure, the transmission circuitry transmits, in a specific transmission occasion, information indicating success or failure in reception of a downlink signal.

A transmission method according to an embodiment of the present disclosure includes: controlling at least one of a plurality of time periods in which a transmission occasion of uplink control information is configured; and performing a repetition transmission of an uplink signal in the plurality of time periods.

The disclosure of Japanese Patent Application No. 2019-149162, filed on Aug. 15, 2019, including the specification, drawings and abstract, is incorporated herein by reference in its entirety.

### INDUSTRIAL APPLICABILITY

An embodiment of the present disclosure is useful for radio communication systems.

### REFERENCE SIGNS LIST

100, 300 Base station

101, 201 Receiver

102 UL transmission detector

103 Reception controller

104 Demodulator/separator

105 Data decoder

106 UCI decoder

107, 203 Control information holder

108 Scheduler

109 Transmission data control information generator

110 Encoder/modulator

111, 211 Transmitter

200, 400 Terminal

202 Demodulator/decoder

204 Transmission controller

205 UCI information generator

206 Data generator

207 Reference signal generator

208 UCI encoder

209 Data encoder

210 Multiplexer/modulator

401 CSI estimator

1. A terminal, comprising:
transmission circuitry, which, in operation, performs a repetition transmission of an uplink signal in a plurality of time periods; and
control circuitry, which, in operation, controls at least one of the plurality of time periods in which a transmission occasion of uplink control information is configured.

2. The terminal according to claim 1, wherein the control circuitry configures the transmission occasion of the uplink control information in any of one or more candidate time periods in which transmission of the uplink signal is started among the plurality of time periods.

3. The terminal according to claim 2, wherein the control circuitry configures the transmission occasion of the uplink control information in a first time period among the plurality of time periods.

4. The terminal according to claim 2, wherein the control circuitry configures the transmission occasion of the uplink control information in each of the one or more candidate time periods in which the transmission of the uplink signal is started among the plurality of time periods.

5. The terminal according to claim 2, wherein the one or more candidate time periods in which the transmission of the uplink signal is started are defined based on the number of the plurality of time periods and a parameter related to the repetition transmission.

6. The terminal according to claim 1, wherein,
the transmission circuitry starts transmission of the uplink signal from any of the plurality of time periods, and
the control circuitry configures the transmission occasion of the uplink control information in in time period(s) (in is an integer of one or more) from the time period in which the transmission of the uplink signal is started.

7. The terminal according to claim 1, wherein the uplink control information indicates a transmission resource of information indicating success or failure in reception of a downlink signal and/or of information indicating a channel state.

8. The terminal according to claim 1, wherein the transmission circuitry transmits, in a specific transmission occasion, information indicating success or failure in reception of a downlink signal.

9. A transmission method, comprising:
controlling at least one of a plurality of time periods in which a transmission occasion of uplink control information is configured; and
performing a repetition transmission of an uplink signal in the plurality of time periods.
